(19) United States
(12) Patent Application Publication
(10) Pub. No.: US 2012/0133581 A1
(43) Pub. Date: May 31, 2012

(54) HUMAN-COMPUTER INTERACTION DEVICE AND AN APPARATUS AND METHOD FOR APPLYING THE DEVICE INTO A VIRTUAL WORLD

(75) Inventors: Qi Cheng Li, Beijing (CN); Jian Wang, Beijing (CN); Yi Min Wang, Beijing (CN); Zi Yu Zhu, Beijing (CN)

(73) Assignee: International Business Machines Corporation, Armonk, NY (US)

(21) Appl. No.: 13/300,846

(22) Filed: Nov. 21, 2011

(30) Foreign Application Priority Data
Nov. 29, 2010 (CN) 201010577036.8

(51) Int. Cl. G09G 5/00

(52) U.S. Cl. 345/156

(57) ABSTRACT

A human-computer interaction device and an apparatus and method for applying the device into a virtual world. The human-computer interaction device is disposed with a sensing device thereon, the sensing device including a manipulation part and a distance sensor. The manipulation part receives a manipulation action of a user's finger, the distance sensor senses a distance of the manipulation part relative to a fixed location and generates a distance signal for characterizing the manipulation action. A virtual world assistant apparatus and a method corresponding to the assistant apparatus is also provided. With the invention, multiple signals of manipulation can be sensed and free control on actions of an avatar can be realized by using the multiple signals.

This application claims priority under 35 U.S.C. 119 from Chinese Application 201010577036.8, filed Nov. 29, 2010, the entire contents of which are incorporated herein by reference.

### BACKGROUND OF THE INVENTION

1. Technical Field

The present invention relates to the field of human-computer interaction with the virtual world, and more particularly, to a device for performing human-computer interactions and an apparatus and method for applying the device in a virtual world.

2. Description of the Related Art

With the rapid development of information technology and the Internet, 3D virtual worlds have been increasingly applied in various scenes to provide vivid simulation of the real world for the user, and to provide an intuitive and immersive user experience. For a typical 3D virtual world system, including a 3D game and a virtual community, the user enters into the virtual world in the form of avatar and controls the activity of the corresponding avatar in the 3D virtual world through various kinds of human-computer interaction devices.

Traditional human-computer interaction devices that can be used in virtual worlds include a mouse, keyboard, touch pad, joystick, handle, track ball, game glove, etc. By manipulating such human-computer interaction devices, users can issue instructions and direct avatars to perform actions in the virtual world according to the instructions. However, in the existing virtual worlds, actions that can be performed by an avatar are usually predefined. FIG. 1 shows an example of a scene in an existing virtual world, Lively by Google Inc., which shows how a user selects an action in the virtual world. As shown in the figure, a series of actions are predefined and stored in the virtual world, and available options to the user are provided in the form of an action list. The action list has listed therein actions currently available to be performed by the user, such as to say hi to somebody, hug him, kick him, dance with him, kiss him and so on. After the user has selected an action with a human-computer interaction device, the virtual world will present or play the selected corresponding animation, so that the avatar will perform the designated action according to the user's selection. However, as shown in the above example, the user can only make a selection from predefined actions, rather than design or customize more detailed actions for avatars by himself, for example, waving a hand to say hi while walking. Such limitations make the existing virtual worlds unable to obtain the desired effect of being more rich and vivid.

The limitation on an avatar's action is mainly due to two aspects. On one hand, the existing human-computer interaction devices are unable to provide multiple signals and instructions simultaneously. For example, a mouse can only provide cursor position navigation and clicking of the left and right buttons, and such simple instructions are hard to support an avatar's more sophisticated action. Also, joysticks, track balls, game gloves, etc., dedicated to 3D games can only provide relatively simple manipulation instructions and are not convenient to carry. On the other hand, due to lack of multiple signals and instructions, the existing virtual world systems are unable to provide richer actions for avatars based on multiple signals and instructions. Therefore, to enhance the expressive force of virtual worlds, it is desired to make improvements on the above aspects, thereby enriching actions and gestures of avatars in virtual worlds and providing a more vivid experience for users.

### SUMMARY OF THE INVENTION

In order to overcome these deficiencies. the present invention provides a human-computer interaction device, disposed with at least one sensing device thereon, the at least one sensing device including: a manipulation part configured to receive a manipulation action of a user's at least one finger; and at least one distance sensor configured to sense a distance of the manipulation part relative to at least one fixed location in the device and generate at least one distance signal for characterizing the manipulation action of the at least one finger.

According to another aspect of the present invention, the present invention provides a virtual world assistant apparatus for applying a human-computer interaction device to a virtual world, the human computer interaction device disposed with at least one sensing device thereon, the at least one sensing device including: a manipulation part configured to receive a manipulation action of a user's at least one finger; and at least one distance sensor configured to sense a distance of the manipulation part relative to at least one fixed location in the device and generate at least one distance signal for characterizing the manipulation action of the at least one finger; and the assistant apparatus including: a receiving unit configured to receive from the human-computer interaction device at least one signal provided by the human-computer interaction device based on the sensed distance and used to characterize the manipulation action of at least one finger; and a mapping unit configured to map the at least one signal to actions of body parts of an avatar in the virtual world.

According to yet another aspect of the present invention, the present invention provides a method for applying a human-computer interaction device to a virtual world, wherein the human computer interaction device is disposed with at least one sensing device thereon, the method including: a receiving step for receiving by the sensing device a manipulation action of a user's at least one finger; a sensing step for sensing by the sensing device a distance of the manipulation part relative to at least one fixed location in the device and generating at least one distance signal for characterizing the manipulation action of the at least one finger; a receiving step for receiving from the human-computer interaction device at least one signal provided by the human-computer interaction device based on the sensed distance used to characterize the manipulation action of at least one finger; and a mapping step for mapping the at least one signal to actions of body parts of an avatar in the virtual world.

### BRIEF DESCRIPTION OF THE SEVERAL VIEWS OF THE DRAWINGS

FIG. 1 shows an example of a scene in an existing virtual world;

FIG. 2A shows a top view of the human-computer interaction device according to an embodiment of the invention;

FIG. 2B shows a section view of the human-computer interaction device of FIG. 2A;

FIG. 3 shows diagrams of a control ball and cooperation between the control ball and fingers according to an embodiment of the invention;

FIG. 4 shows a schematic block diagram of the virtual world assistant apparatus according to an embodiment of the invention;

FIG. 5 shows the correspondence relationship between different fingers and parts of an avatar according to an embodiment of the invention;

FIG. 6A shows the mapping relationship between a finger's action parameters and an avatar's actions according to an embodiment of the invention;

FIG. 6B shows the mapping relationship between a different finger's action parameters and an avatar's actions according to an embodiment of the invention;

FIG. 6C shows the mapping relationship between a different finger's action parameters and an avatar's actions according to an embodiment of the invention;

FIG. 7 shows a flowchart of a method for applying the human-computer interaction device into a virtual world according to an embodiment of the invention; and

FIG. 8 shows a detailed flowchart of the mapping step according to an embodiment of the invention.

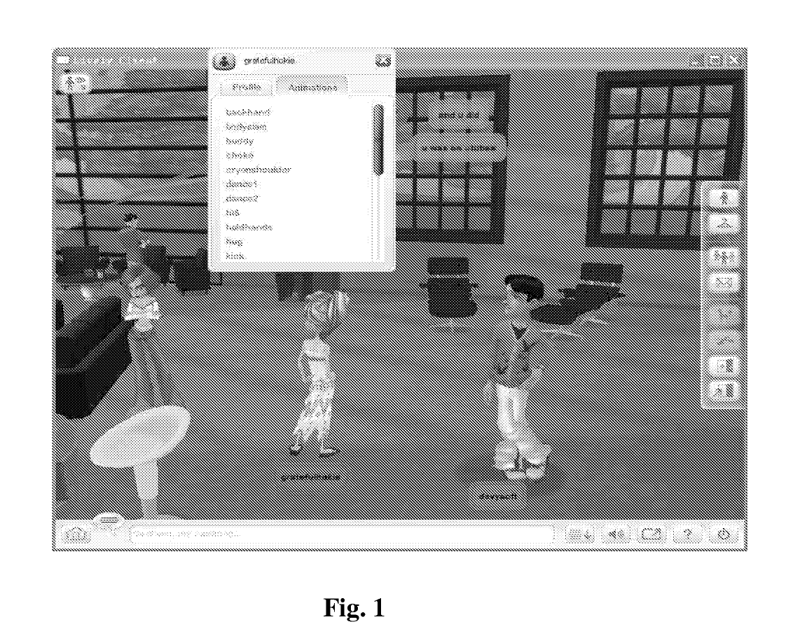

### DETAILED DESCRIPTION OF THE PREFERRED EMBODIMENTS

Detailed embodiments of the invention will be described in conjunction with the accompanying drawings. It should be appreciated that the following description of the detailed embodiments are to explain the execution of an example of the invention, rather to impose any limitation on the scope.

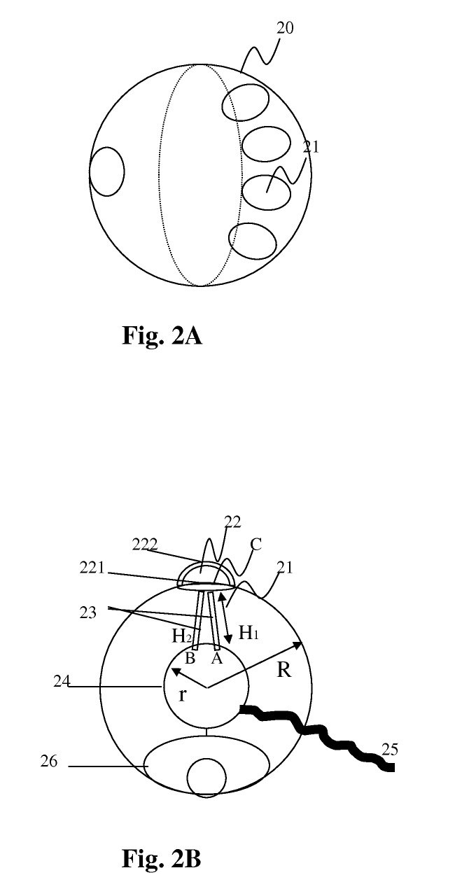

FIG. 2A shows a top view of the human-computer interaction device according to an embodiment of the invention; FIG. 2B shows a section view of the human-computer interaction device of FIG. 2A. In general, the human-computer interaction device of the embodiment of the invention is designed as a shape that is adapted to be held by human's single hand, e.g., spherical, semi spherical, ellipsoidal, etc. In the detailed example shown in FIGS. 2A and 2B, the human-computer interaction device 20 is shown as spherical, and it is also referred to as a control ball herein. The size of the control ball is approximately the size of a human palm, such that when manipulating the control ball, a sing human hand can naturally and loosely hold it. In the detailed example shown in FIG. 2A, control ball 20 has a certain amount of elasticity. Five sensing devices 21 are disposed on an elastic part at locations corresponding to the five fingers of a single human hand, each of which is for sensing a manipulation action of a finger on the control ball. The structure of one sensing device 21 is more clearly shown in the section view of FIG. 2B.

In the example shown in FIG. 2B, a sensing device 21 includes a manipulation part 22 and a distance sensor 23. The manipulation part 22 can be in touch with and fit to a finger, and it can receive manipulation from a finger on the control ball. The distance sensor 23 is for sensing the distance of the manipulation part 22 relative to fixed locations in the control ball and generating signals representing distances and related to a finger's action.

Specifically, the manipulation part 22 includes a pressing pad 221 and a ring 222. The pressing pad 221 is disposed on the surface of the control ball and the ring 222 is formed on the surface of the control ball at a location corresponding to the pressing pad 221. The ring 222 and the pressing pad 221 are arranged in coordination with each other, so as to establish a clearance for a finger. When manipulating the control ball, the finger enters into the space between the ring 222 and the pressing pad 221 so as to be surrounded by them, and performs actions along the normal and tangential directions of the spherical surface, and along combinations of the two. The action along the normal direction of the spherical surface includes pressing the surface of the elastic control ball, that is, pressing downwards on the pressing pad 221; and lifting from the surface of the control ball, that is, pulling upwards on the ring 222. The action along the tangential direction of the spherical surface includes swinging the finger parallel to the surface of the control ball.

Distances H1 and H2 are formed between the manipulation part 22 and two fixed locations A and B within the control ball. Two distance sensors 23 can be disposed along these two distances for sensing the magnitudes of H1 and H2, and generating signals representing the distances H1 and H2. When the finger performs the above manipulation action on the manipulation part 22, the action of the finger will cause variations in distances H1 and H2, which will be sensed and captured by the distance sensors 23, thereby generating distance signals that can reflect the action of the finger.

The distance sensor 23 can be implemented in various manners. In one embodiment, the distance sensor 23 is formed by a capacitor or resistor device with values that vary with distance, and determine the magnitude of the distance by sensing the value of the capacitor or resistor. In another embodiment, springs are disposed along distances H1 and H2, and force sensing devices are disposed at one or both ends of the springs as distance sensor 23. In this case, the distance sensor 23 determines the magnitude of the distance by sensing the magnitude of the force applied on the springs. It can be appreciated that, a person skilled in the art can select an appropriate manner to determine the distance.

In the embodiment shown in FIG. 2B, the control ball 20 also includes a ball-like processing circuit 24. In this case, the fixed locations A and B can be arranged on the sphere formed by the processing circuit 24. The processing circuit 24 is formed by a dedicated circuit and is configured to receive signals generated by the distance sensor 23 so as to calculate distances H1 and H2 and variations thereof. Optionally, the processing circuit 24 may further be configured to calculate the amplitude of the movement of a finger along both the tangential and normal directions of the spherical surface based on distances H1 and H2. Since the locations of A and B are fixed, after obtaining H1 and H2, it is very easy to calculate the position of the triangle vertex C. Using a triangulation relationship, the location of the manipulation part 22 can be determined, and in turn, the amplitude of the movement of a finger along the tangential and normal directions can be determined. Further, the processing circuit 24 can transmit the obtained result via a cable 25 to a connected computer system that supports virtual worlds. In one implementation, the communication between the processing circuit 24 and the computer system can be realized in a wireless manner by using techniques known in the art.

Optionally, in the embodiment of FIG. 2B, the control ball 20 may also include a traditional mouse device 26. The mouse device 26 can be used to realize functions such as cursor navigation and button selection in the manner known in prior art.

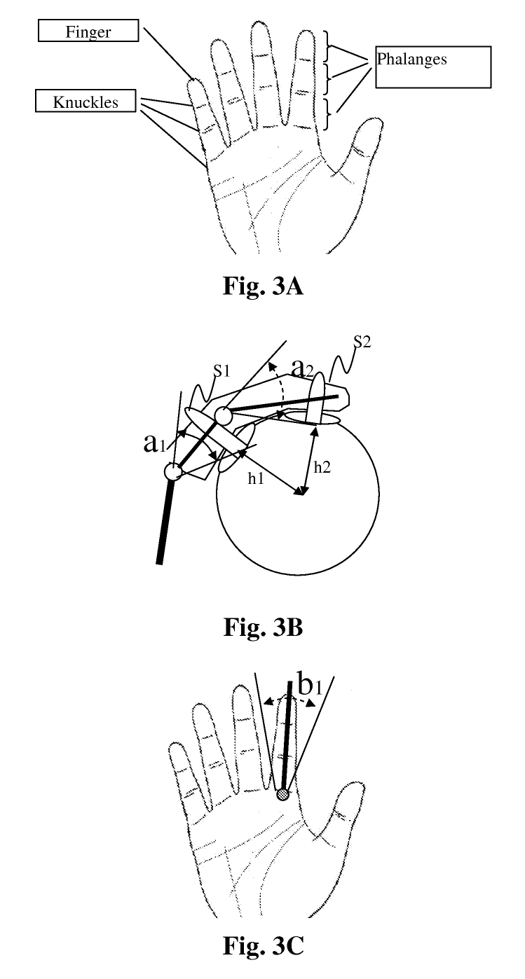

FIG. 3 shows diagrams of the control ball and cooperation between the control ball and fingers according to an embodiment of the invention. As shown in FIG. 3A, a human finger has three knuckles, referred to as a first, second and third knuckle, starting from the knuckle connected to the palm. These three knuckles divide a finger into three phalanges, which are in turn referred to as a first to third phalanx (for the thumb, conventionally it is considered that it only has a first and second knuckle, corresponding to a first and second phalanx). In order to better cooperate with fingers and improve the controllability of the control ball, in the control ball shown in FIG. 3B, two sensing devices S1 and S2 are disposed for one finger. Each sensing device, as shown in FIG. 2B, includes a manipulation part formed by a pressing pad and ring and distance sensors, so that it can sense the actions of fingers on the control ball via the manipulation part. When the finger naturally enters into the two rings to hold the control ball, the two sensing devices S1 and S2 are situated on the first and third phalanx of the finger, respectively. For the thumb, it can be considered that the two sensing devices are on the first and second phalanx, respectively.

The manipulation part of the sensing device S1 located at the first phalanx is used to receive the action of the first phalanx on the control ball, and the distance sensor in sensing device S1 is used to sense the distance h1 of the corresponding manipulation part relative to a fixed location (for example, the center of the sphere). With variations in distance h1, the action amplitude of the first phalanx on the pressing pad and ring of sensing device S1 can be determined, and thus so can the vertical movement angle a1 of the first phalanx around the first knuckle. Similarly, sensing device S2 is used to sense distance h2 of the manipulation part upon which the third phalanx acts relative to a fixed location. With variations in distance h2, the action of the third phalanx on the control ball can be determined. Since the third phalanx generally can not perform actions independently, but instead performs actions around the second knuckle along with the second phalanx, variations in distance h2 correspond to the vertical movement angle a2 of the finger around the second knuckle. For the thumb, since sensing device S2 is located at the second phalanx, the sensed variation in distance h2 can be directly corresponded to the vertical movement angle a2 of the second phalanx of the thumb around the second knuckle.

The sensing devices S1 and S2 each may include two distance sensors as shown in FIG. 2B to sense two distances of corresponding manipulation parts to fixed locations, thereby further determining movement of a finger along the surface direction of the control ball. This movement can be corresponded to the amplitude of a horizontal swing of the finger around the first knuckle in the plane of the palm, as indicated by angle b1 in FIG. 3C.

Optionally, the control ball of FIG. 3B may include therein a processing circuit for directly converting distances sensed by sensing devices S1 and S2 into the above angles a1, a2 and b1 and transmitting them to a computer system that supports virtual worlds. In one implementation, the processing circuit can be omitted and the sensed distance signals can be directly transmitted to the computer system by the sensing devices, then angles a1, a2 and b1 are derived by utilizing the processing and calculation capabilities of the computer system.

Although two detailed examples of human-computer interaction device are shown above, it is appreciated that those skilled in the art can make modifications to obtain various implementations based on precision requirements.

For example, the number of sensing devices and disposition manner thereof can be modified as needed. In one embodiment, a sensing device is disposed for each finger of a single hand. In another implementation, sensing devices are disposed for less than each finger of a single hand. In one embodiment, two sensing devices are disposed for each finger as shown in FIG. 3B; in another implementation, two sensing devices are disposed only for some fingers, such as the relatively agile index and middle fingers, and one sensing device is disposed for the other fingers. Alternatively, to capture finer actions, more sensing devices (for example, three or more) can be disposed for a single finger.

The structure of the sensing device can also be modified as needed. In one embodiment, the manipulation part only includes the pressing pad, so that only the pressing of a finger on the control ball can be received. In another embodiment, the manipulation part only includes the ring, so that only a finger's lifting action from the control ball is received. In the case that only the movement of a finger along the normal direction of control ball needs to be sensed, that is, in the case that only the press depth and lift height of the finger needs to be sensed, the sensing device can contain only one distance sensor for sensing distance from the manipulation part to the one fixed location in the control ball.

The above fixed location may also be set as needed. In the case that there is a concentric processing circuit in the control ball, the fixed location can be set at a particular location of the processing circuit. In one implementation, the center of the control ball may generally be considered as the fixed location.

In addition, although the overall control ball has an elastic surface in the embodiment of FIG. 2B, in one implementation, the overall control ball may not be elastic, and the elasticity can be merely provided by the manipulation part in the sensing device, so as to receive a finger's pressing, lifting and translation actions.

Furthermore, although the human-computer interaction device is embodied as a control ball in the above examples, the human-computer interaction device may also be realized by using other forms, as long as it is adapted to be held by a human hand.

It is appreciated that, although various examples of modified implementation of human-computer interaction devices have been described above, those skilled in the art can make more modifications based on actual needs after reading the description. It is intended that all such modifications are covered in the scope of the invention and there is no need to exhaustively list all such modifications.

As mentioned above, the human-computer interaction device is capable of simultaneously sensing multi-dimensional manipulations of multiple fingers through a plurality of sensing devices disposed thereon, thereby capturing a plurality of variables, which provides a basis and possibility of enriching the actions of an avatar in virtual worlds.

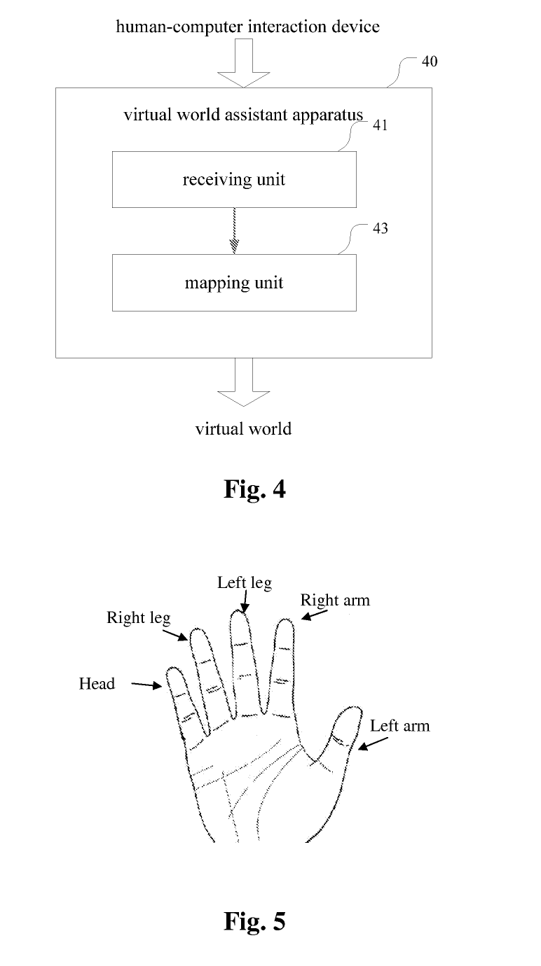

To enhance the expressive force of the virtual world with the above human-computer interaction device, embodiments of the invention also provide a virtual world assistant apparatus for applying the above human-computer interaction device in the virtual world. FIG. 4 shows a schematic block diagram of a virtual world assistant apparatus according to an embodiment of the invention. As shown in FIG. 4, the virtual world assistant apparatus 40 includes a receiving unit 41 and a mapping unit 43. The receiving unit 41 is configured to receive from the above human-computer interaction device at least one signal that is provided by the human-computer interaction device based on the sensed distance and is used to characterize the manipulation action of at least one finger; the mapping unit 43 is configured to map the at least one signal to the actions of body parts of an avatar in the virtual world.

The signal provided by the human-computer interaction device based on the sensed distance can be a distance signal that directly represents a distance, or can be a processed signal converted based on the sensed distance. Specifically, in one implementation, the at least one signal received by the receiving unit 41 is a distance signal directly generated by the sensing devices in the human-computer interaction device. The mapping unit 43 can directly map these distance signals to body actions of avatars in the virtual world. Alternatively, the mapping unit 43 may first convert the distance signals into action parameters that represent a finger's manipulation actions, such as the vertical movement angle a1 of the finger around the first knuckle, vertical movement angle a2 around the second knuckle, horizontal swing angle b1 around the first knuckle, etc., and then map these action parameters to actions of avatars in the virtual world. In another implementation, the processing circuit provided in the human-computer interaction device converts distance signals into action parameters. In this case, receiving unit 41 receives signals representing action parameters converted based on distance signals, and thus the mapping unit 43 may map the action parameters to the actions of avatars in the virtual world. It is appreciated that, the communication between the receiving unit 41 and the human-computer interaction device can be performed in a wired or wireless manner.

The mapping process of the mapping unit 43 will be described in the following in conjunction with a detailed embodiment. In this detailed embodiment, as shown in FIG. 3B, two sensing devices are disposed on the human-computer interaction device for each finger. Based on sensing results of the sensing devices, the mapping unit 43 can receive the action parameters of each finger and map the action parameters of all five fingers to the actions of limbs and the head of an avatar in the virtual world. FIG. 5 shows a corresponding relationship between different fingers and body parts of an avatar according to an embodiment of the invention. In the embodiment of FIG. 5, the mapping unit 43 maps action parameters of the thumb to actions of the left arm of an avatar in the virtual world, maps action parameters of the index finger to actions of the right arm of the avatar, maps action parameters of the middle finger to the actions of the left leg of the avatar, maps action parameters of the ring finger to actions of the right leg of the avatar, and maps action parameters of the little finger to actions of the head of the avatar. The present embodiment uses this arrangement because the thumb and index finger are relatively agile and are adapted to manipulate the upper arms whose actions are relatively finer; the little finger is not as agile and is adapted to manipulate the head which has fewer actions. Further, action parameters of each finger all include the vertical movement angle a1 of the finger around the first knuckle, vertical movement angle a2 around the second knuckle, and horizontal swing angle b1 around the first knuckle. The diagram of parameters a1, a2 and b1 are shown as FIGS. 3B and 3C. Mapping the relationship between each action parameter and the action of the avatar will be described in the following.

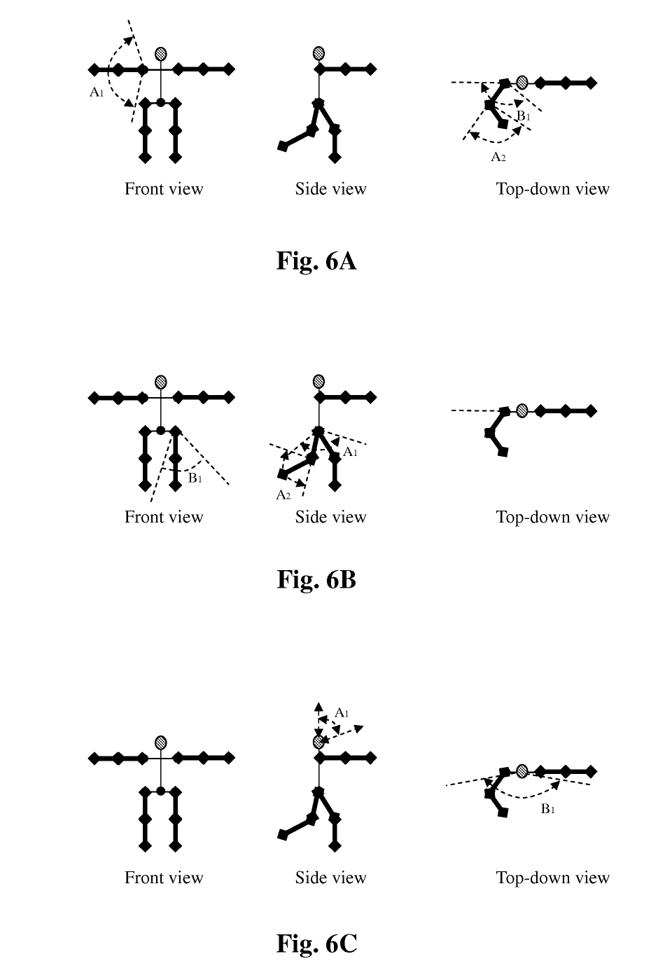

FIG. 6A-6C shows the mapping relationship between a finger's action parameters and an avatar's actions according to an embodiment of the invention. FIG. 6A shows mapping between action parameters of the index finger and actions of the right arm of the avatar in a front view, side view and top view. As shown in the figure, the vertical movement angle a1 of the index finger around the first knuckle is mapped to the vertical swing angle A1 of avatar's right arm around the shoulder in the body plane, the horizontal swing angle b1 of the index finger around the first knuckle is mapped to the horizontal swing angle B1 of the avatar's right arm around the shoulder in the horizontal plane, and the vertical movement angle a2 of the index finger around the second knuckle is mapped to the swing angle A2 of forearm of right arm relative to the upper arm. With such mapping, the manipulation actions of the index finger on a human-computer interaction device are converted into free control on the right arm of the avatar in virtual world, so that the avatar can present different right arm actions according to actions of the index finger. Similarly, the mapping relationship between action parameters of the thumb and actions of the left arm are the same as that shown in FIG. 6A and will be omitted here for brevity.

FIG. 6B shows the mapping between action parameters of the middle finger and actions of the left leg of the avatar in a front view, side view and top view. As shown in the figure, the horizontal swing angle b1 of the middle finger around the first knuckle is mapped to the left-and-right swing angle B1 of the avatar's left leg around the hip joint in the body plane, the vertical movement angle a1 of the middle finger around the first knuckle is mapped to the back-and-forth swing angle A1 of the avatar's left leg around the hip joint, and the vertical movement angle a2 of the middle finger around the second knuckle is mapped to the swing angle A2 of the lower left leg relative to the thigh. With such mapping, the manipulation actions of the middle finger on a human-computer interaction device are converted into free control on the left leg of an avatar in the virtual world, such that the avatar can present different left leg actions according to actions of the middle finger. Similarly, the mapping relationship between the action parameters of the ring finger and actions of the right leg are the same as that shown in FIG. 6B and will be omitted for brevity.

FIG. 6C shows the mapping between action parameters of the little finger and actions of the head of the avatar in a front view, side view and top view. In comparison to the other fingers, the agility of the little finger is low, and thus actions of the little finger are mapped to the head which has relatively simple actions, and only action parameters a1 and b1 of the little finger are used. Specifically, as shown in the figure, the horizontal swing angle b1 of the little finger around the first knuckle is mapped to the horizontal left-and-right swing angle B1 of the avatar's head, namely, head shaking angle B1, and the vertical movement angle a1 of the little finger around the first knuckle is mapped to the vertical up-and-down swing angle A1 of the avatar's head, namely, nodding angle A1. With such mapping, the manipulation actions of the little finger on a human-computer interaction device are converted into free control of the head of the avatar in the virtual world, so that the avatar can present different head actions according to actions of the little finger.

With the above mapping, the virtual world assistant apparatus 40 converts manipulation actions of each finger captured by the human-computer interaction device into actions of respective body parts of the avatar in the virtual world. Thus, each body part of the avatar can be simultaneously and separately controlled, so that the avatar can perform any user-desired, un-predefined actions according to manipulation of a user's multiple fingers.

It is appreciated that, although the mapping relationship between action parameters of a finger and actions of an avatar in one embodiment is described in detail above, depending on the configuration of human-computer interaction device and requirement on controllability of the actions of the avatar, the mapping unit 43 can perform mapping according to other mapping relationships. For example, the mapping unit 43 can map each finger to respective body parts of an avatar in a different manner, for example, map actions of the thumb to actions of the head, map actions of the index finger to actions of the leg, etc. For each action parameter of the finger, the mapping unit 43 may also perform mapping in a different manner. For example, as to the relationship between action parameters of the index finger and actions of the right arm, the mapping unit 43 may map the horizontal swing angle b1 of the index finger to the up-and-down swing angle A1 of the right arm, and so on. Furthermore, as mentioned above, the human-computer interaction device itself may have different configuration manners, such as disposing sensing devices only for some fingers, disposing only one sensing device for each finger, etc. Accordingly, the number and type of signals provided by the human-computer interaction device will also vary with the above configurations. In this case, the mapping unit 43 can be modified to perform mapping according to the received signals. For example, in the case that the receiving unit 41 only receives signals related to actions of the index finger, the mapping unit 43 will only perform mapping on signals of the index finger, such as by selectively mapping them to the head actions.

For a particular signal relevant to a finger action, the mapping unit 43 can perform mapping according to pre-defined and pre-stored mapping relationships. However, in one implementation, the mapping relationship may also be set by the user. In particular, in one embodiment, the assistant apparatus 40 may further include a setting unit (not shown) configured to receive mapping relationships set by users. Through the setting unit acting as an interface, users can set desired mapping relationships according to their own manipulation habits or their own desired manipulation settings. For example, it can be set to map actions of the thumb to the avatar's head action, and more specifically, to map the horizontal swing angle b1 of the thumb to the nodding amplitude A1, and so on. Then, the mapping unit 43 performs mapping of the finger signals to avatar actions according to the mapping relationship set by users.

To make actions of the avatar more harmonious and to enhance the operability of the human-computer interaction device, the assistant apparatus 40 may further include a coordinating unit (not shown) configured to coordinate actions of the avatar according to the user's own manipulation habits or their own desired manipulation settings.

In one detailed embodiment, as shown in FIG. 6A, the horizontal swing angle b1 of the thumb and index finger are mapped to the horizontal swing angle B1 of the right and left arm of the avatar, respectively. However, since the thumb and index finger have differences in agility and movement abilities, the maximum horizontal swing angle b1 of the thumb and index finger can be different. This may possibly cause movement amplitudes of the left and right arm of the avatar to be inconsistent and unharmonious. For this reason, the coordinating unit may obtain a limit value of each finger with respect to each action parameter, and make the limit value correspond to the limit amplitude of avatar actions. For example, for the above described arm actions, the coordinating unit may obtain the maximum horizontal swing angle b1ₘₐₓ that can be reached by the index finger, make that angle correspond to maximum horizontal swing angle B1ₘₐₓ (such as 180°) that can be reached by the right arm of the avatar, and make the swing angle b1=0 of the index finger in its natural state correspond to the horizontal natural state B1=0 of the right arm. For an angle b1 between 0 and b1ₘₐₓ, the coordinating unit calculates its proportion relative to b1ₘₐₓ. Thus, when performing mapping, the mapping unit would map b1 to angle B1 of the corresponding proportion between 0 and B1ₘₐₓ according to the calculated proportions. The same operation is also performed for the thumb. Thus, the left and right arm of the avatar can accomplish corresponding actions symmetrically and harmoniously under control of the thumb and index finger, respectively.

To obtain the limit value of each finger with respect to each action parameter, in one embodiment, the coordinating unit directs the user to input the limit value through an interface program. For example, the coordinating unit can prompt the user to lift up the index finger as high as possible and then press down the human-computer interaction device as low as possible, and take signals obtained from the human-computer interaction device at this moment as limit value signals, thereby directly obtaining the index finger's vertical movement limit angles a1ₘₐₓ and a2ₘₐₓ.

In another embodiment, the coordinating unit may learn the limit value of action parameters by training and self-studying. For example, the coordinating unit may provide to a user a segment of an avatar's demonstrative actions (such as a segment of dance), and ask the user to control his own avatar to imitate the actions. By observing differences between the actions of the user's avatar and the demonstrative actions, the coordinating unit may determine the deviation of the user's action parameter range from a standard action parameter range and then transmit the deviation to the mapping unit 43, so that it may correct that deviation when mapping.

For different users, the coordinating unit may determine the manipulation habits of different users via the above manner of directing users to input values or the manner of self-learning, and store that manipulation habit information as configuration files for reference by the mapping unit. Thus, when mapping, the mapping unit 43 may make certain degrees of correction on the avatar's actions according to user's manipulation habits based on information in the configuration files, so as to make the mapped actions within a reasonable range.

Based on the above described detailed embodiments, the virtual world assistant apparatus 40 may apply the human-computer interaction device 20 in controlling the avatar's actions, such that users can freely control the avatar in the virtual world to make various desired actions through manipulating the human-computer interaction device 20.

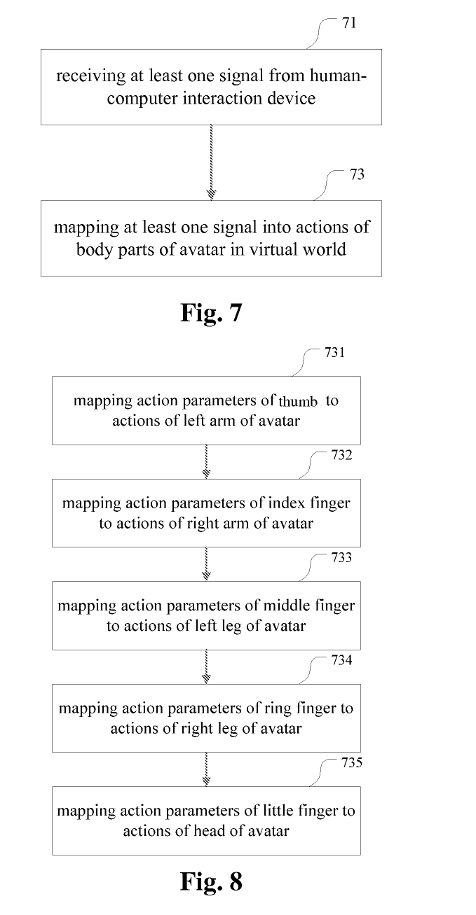

Based on the same inventive concept as the assistant apparatus 40, embodiments of the invention also provide a method for applying a human-computer interaction device in a virtual world. FIG. 7 shows a flowchart of a method for applying a human-computer interaction device to a virtual world according to an embodiment of the invention. As shown in FIG. 7, the method includes a receiving step 71 and a mapping step 73. In the receiving step 71, at least one signal is received from the human-computer interaction device, and the at least one signal is provided by the human-computer interaction device based on the sensed distance and is used to characterize the manipulation action of at least one finger; in the mapping step 73, the at least one signal is mapped to the action of the body part of an avatar in the virtual world.

In particular, in one implementation, the at least one signal received at step 71 are signals representing distance directly generated by sensing devices in the human-computer interaction device. Based on this, in the mapping step 73, these distance signals can be directly mapped to body actions of an avatar in the virtual world. Alternatively, in the mapping step 73, the distance signals may first be converted into action parameters that represent manipulation actions of fingers, for example, vertical movement angle a1 of the finger around the first knuckle, vertical movement angle a2 around the second knuckle, horizontal swing angle b1 around the first knuckle, etc., then these action parameters are mapped to actions of avatars in the virtual world. In another implementation, the processing circuit provided in the human-computer interaction device has already converted distance signals into action parameters. In this case, signals are received in the receiving step 71 representing action parameters converted based on distance signals. Accordingly, in the mapping step 73, the action parameters are mapped to actions of the avatar in the virtual world.

The mapping process of the mapping step 73 will be described in the following in conjunction with a detailed embodiment. In this detailed embodiment, in the mapping step 71, signals representing action parameters for each of the five fingers are received, and thus in the mapping step 73, the five fingers are first mapped to limbs and the head of an avatar in the virtual world. FIG. 8 shows a detailed flowchart of the mapping step according to an embodiment of the invention. In the example of FIG. 8, the mapping step 73 includes: a step 731 for mapping action parameters of the thumb to actions of the left arm of an avatar in a virtual world, a step 732 for mapping action parameters of the index finger to actions of the right arm of the avatar, a step 733 for mapping action parameters of the middle finger to actions of the left leg of the avatar, a step 734 for mapping action parameters of the ring finger to actions of the right leg of the avatar, and a step 735 for mapping action parameters of the little finger to actions of the head of the avatar.

Further, action parameters of each finger include a vertical movement angle a1 of the finger around the first knuckle, vertical movement angle a2 around the second knuckle, and horizontal swing angle b1 around the first knuckle. Therefore, the mapping step 73 needs to map each action parameter to a particular body part action of the avatar. In one example, step 732 includes: mapping the vertical movement angle a1 of the index finger to a vertical swing angle A1 of the avatar's right arm around the shoulder in the body plane, mapping the horizontal swing angle b1 of the index finger to the horizontal swing angle B1 of the avatar's right arm around the shoulder in the horizontal plane, and mapping the vertical movement angle a2 of the index finger to the swing angle A2 of the forearm of the right arm relative to the upper arm. Similarly, the process of mapping action parameters of the thumb to actions of the left arm in step 731 is the same as that in step 732 and will be omitted for brevity.

For the process of mapping action parameters of the middle finger, the step 733 includes: mapping the horizontal swing angle b1 of the middle finger to the left-and-right swing angle B1 of the avatar's left leg around the hip joint in the body plane, mapping the vertical movement angle a1 of the middle finger to the back-and-forth swing angle A1 of the avatar's left leg around the hip joint, and mapping the vertical movement angle a2 of the middle finger to the swing angle A2 of the lower left leg relative to the thigh. Similarly, the process of mapping action parameters of the ring finger to actions of the right leg in step 734 is the same as that in step 733 and will be omitted for brevity.

For the process of mapping action parameters of the little finger, the step 735 includes: mapping the horizontal swing angle b1 of the little finger to the shaking angle B1 of the avatar's head, and mapping vertical movement angle a1 of the little finger to the nodding angle A1 of the avatar's head.

With the above mapping process, manipulation signals of each finger captured by the human-computer interaction device are converted into actions of respective body parts of the avatar in the virtual world, and thus, each body part of the avatar can be simultaneously and separately controlled.

It is appreciated that, although specific mapping steps in one embodiment are described in detail above, depending on the configuration of the human-computer interaction device and requirements on controllability of the actions of an avatar, in the mapping step 73, the mapping can be performed according to other mapping relationships. The examples of other mapping relationship are similar to the description referring to the assistant apparatus and will be omitted for brevity.

For particular signals relevant to finger actions, the mapping relationship upon which the mapping is performed in the mapping step 73 can be pre-defined or can be set according to a user's needs. Accordingly, in one implementation, the method of FIG. 7 can also include a setting step (not shown) in which a mapping relationship set by the user is received. Thus, in the mapping step 73, the mapping can be performed according to the mapping relationship set by the user.

To make actions of an avatar more harmonious and to enhance operability of human-computer interaction device, the method of FIG. 7 may further include a coordinating step (not shown) for coordinating actions of the avatar according to the manipulation habits of a user. In one embodiment, the coordinating step includes: obtaining limit values of each finger with respect to each action parameter, and converting each action parameter within the limit value to a proportion relative to the limit value. Thus, in the mapping step, based on the calculated proportion, the action parameter can be mapped to the avatar's action with amplitudes of corresponding proportion. This enables left and right arms, and left and right legs of the avatar to accomplish corresponding actions symmetrically and harmoniously under the control of different fingers.

To obtain the limit value of each finger with respect to each action parameter, in one embodiment, in the coordinating step, each limit value is directly obtained via the user's input. According to another embodiment, in the coordinating step, the limit value of the action parameter is learned by training and self-studying.

Thus, the method shown in FIG. 7 for applying a human-computer interaction device to a virtual world can convert a user's manipulation on the human-computer interaction device into actions of an avatar, such that the user can freely control the avatar in the virtual world to make various desired actions through manipulating the human-computer interaction device. More specific descriptions and illustrations consistent with the above description of the assistant apparatus will be omitted here for brevity.

Those skilled in the art can appreciate that, the above assistant apparatus for applying a human-computer interaction device to a virtual world and the method thereof can be implemented by using computer executable instructions and/or control codes contained in a processor, for example, codes provided on carrier medium such as a magnetic disk, CD or DVD-ROM, programmable memory such as read-only memory (firmware) or a data carrier such as an optical or electrical signal carrier. The apparatus and its units of the embodiments can be implemented by a hardware circuit such as a very large scale integrated circuit or gate array, semiconductor logic chip, transistor, etc., or programmable hardware device such as a field programmable gate array, programmable logic device, etc., or by software executed by various types of processors, or by a combination of the above hardware circuits and software. Software and program code for carrying out operations of the present invention can be written in any combination of one or more programming languages, including but not limited to an object oriented programming language such as Java, Smalltalk, C++ or the like and conventional procedural programming languages, such as the “C” programming language or similar programming languages. The program code can be executed on a computer locally or remotely to accomplish the intended operations.

Although the human-computer interaction device, the apparatus and method for applying the human-computer interaction device into virtual world of the present invention have been described above in detail in conjunction with specific embodiments, the invention is not limited thereto. Those skilled in the art can make various changes, substitutions and modifications to the invention under the teaching of the description without departing from the spirit and scope of the invention. It should be appreciated that, all such changes, substitutions and modifications still fall into the scope of the invention.

What is claimed is:

1. A human-computer interaction device, disposed with at least one sensing device thereon, the at least one sensing device comprising:
a manipulation part configured to receive a manipulation action of a user's at least one finger; and
at least one distance sensor configured to sense a distance of said manipulation part relative to at least one fixed location in said device and generate at least one distance signal for characterizing said manipulation action of said at least one finger.

2. The human-computer interaction device according to claim 1,
wherein said manipulation part comprises at least one of a pressing pad and a ring;
wherein said pressing pad is used to receive a finger press on said manipulation part; and
wherein said ring is used to receive a finger lift from said manipulation part.

3. The human-computer interaction device according to claim 2, wherein said at least one distance sensor is used to sense two distances of said manipulation part relative to two fixed locations in said device.

4. The human-computer interaction device according to claim 1, wherein said at least one sensing device comprises two or more sensing devices disposed for different parts of a same finger.

5. The human-computer interaction device according to claim 1, further comprising a processing circuit configured to receive said at least one distance signal and calculate action parameters of said at least one finger according to said received signal.

6. The human-computer interaction device according to claim 5, wherein said processing circuit transmits said action parameters to a system that supports a virtual world.

7. A virtual world assistant apparatus for applying a human-computer interaction device to a virtual world,
the human computer interaction device disposed with at least one sensing device thereon, the at least one sensing device comprising:
a manipulation part configured to receive a manipulation action of a user's at least one finger; and
at least one distance sensor configured to sense a distance of said manipulation part relative to at least one fixed location in said device and generate at least one distance signal for characterizing said manipulation action of said at least one finger; and
the assistant apparatus comprising:
a receiving unit configured to receive from said human-computer interaction device at least one signal provided by said human-computer interaction device based on said sensed distance and used to characterize said manipulation action of at least one finger; and
a mapping unit configured to map said at least one signal to actions of body parts of an avatar in said virtual world.

8. The assistant apparatus according to claim 7, wherein said at least one signal is a signal representing distance, said mapping unit converts said at least one signal into an action parameter of at least one finger.

9. The assistant apparatus according to claim 7, wherein said at least one signal is a signal converted based on said sensed distance, and said signal represents an action parameter of at least one finger.

10. The assistant apparatus according to claim 8, wherein said mapping unit is configured to map said action parameter of one finger to an arm action of said avatar and map said action parameter of another finger to a leg action of said avatar.

11. The assistant apparatus according to claim 7, further comprising a setting unit configured to receive a mapping relationship set by a user, and wherein said mapping unit is configured to map said at least one signal according to said mapping relationship received by said setting unit.

12. The assistant apparatus according to claim 7, further comprising a coordinating unit configured to coordinate actions of said avatar according to manipulation habits of a user.

13. The assistant apparatus according to claim 12, wherein said coordinating unit is further configured to:
obtain a limit value of said manipulation action of at least one finger;
make said limit value correspond to an action limit of said body parts of said avatar; and
make said manipulation action within said limit value proportionally correspond to an action amplitude of said body parts of said avatar.

14. A method for applying a human-computer interaction device to a virtual world, wherein said human computer interaction device is disposed with at least one sensing device thereon, the method comprising:
a receiving step for receiving by said sensing device a manipulation action of a user's at least one finger;
a sensing step for sensing by said sensing device a distance of said manipulation part relative to at least one fixed location in said device and generating at least one distance signal for characterizing said manipulation action of said at least one finger;
a receiving step for receiving from said human-computer interaction device at least one signal provided by said human-computer interaction device based on said sensed distance used to characterize said manipulation action of at least one finger; and
a mapping step for mapping said at least one signal to actions of body parts of an avatar in said virtual world.

15. The method according to claim 14, wherein said at least one signal is a signal representing distance, and in said mapping step, said at least one signal is converted into an action parameter of said at least one finger.

16. The method according to claim 14, wherein said at least one signal is a signal converted based on said sensed distance, and said signal represents an action parameter of at least one finger.

17. The method according to claim 15, wherein said mapping step comprises:
mapping said action parameter of one finger to an arm action of said avatar; and
mapping an action parameter of another finger to a leg action of said avatar.

18. The method according to claim 14, further comprising:
receiving a mapping relationship set by said user;
and in said mapping step, said at least one signal is mapped according to said mapping relationship set by said user.

19. The method according to claim 14, further comprising a coordinating step for coordinating actions of said avatar according to a manipulation habit of said user.

20. The method according to claim 19, wherein said coordinating step comprises:
obtaining a limit value of said manipulation action of at least one finger;
making said limit value correspond to an action limit of said body parts of said avatar; and
making said manipulation action within said limit value proportionally correspond to an action amplitude of said body parts of said avatar.
